(19) United States
(12) Patent Application Publication
(10) Pub. No.: US 2023/0342198 A1
(43) Pub. Date: Oct. 26, 2023

(54) METHOD FOR REPRODUCIBLE PARALLEL SIMULATION AT ELECTRONIC SYSTEM LEVEL IMPLEMENTED BY MEANS OF A MULTI-CORE DISCRETE-EVENT SIMULATION COMPUTER SYSTEM

(71) Applicant: COMMISSARIAT A L'ENERGIE ATOMIQUE ET AUX ENERGIES ALTERNATIVES, Paris (FR)

(72) Inventors: Gabriel BUSNOT, BAGNEUX (FR); Tanguy SASSOLAS, Gif Sur Yvette (FR); Nicolas VENTROUX, Gif-sur-Yvette (FR)

(21) Appl. No.: 17/767,908

(22) PCT Filed: Oct. 8, 2020
(86) PCT No.: PCT/EP2020/078339

§ 371 Date: Apr. 10, 2022

(30) Foreign Application Priority Data
Oct. 11, 2019 (FR) 1911332

(51) Int. Cl. G06F 9/48; G06F 9/52; G06F 9/38

(52) U.S. Cl. CPC G06F 9/4887; G06F 9/52; G06F 9/3877

(57) ABSTRACT

A method for reproducible parallel discrete-event simulation at electronic system level implemented by means of a multi-core computer system, the simulation method comprising a succession of evaluation phases, implemented by a simulation kernel executed by the computer system, comprising the following steps: parallel process scheduling; dynamic detection of shared addresses of at least one shared memory of an electronic system simulated by concurrent processes, at addresses of the shared memory, using a state machine, respectively associated with each address of the shared memory; avoidance of access conflicts at addresses of the shared memory by concurrent processes, by pre-emption of a process by the kernel when the process introduces an inter-process dependency of “read after write” or “write after read or write” type; verification of access conflicts at shared-memory addresses by analysis of the inter-process dependencies using a trace of the accesses to the shared-memory addresses of each evaluation phase and a search for cycles in an inter-process dependency graph; backtracking, upon detection of at least one conflict, to restore a past state of the simulation after determination of a conflict-free order of execution of the processes of the conflictual evaluation phase during which the conflict is detected, upon a new simulation that is identical until the excluded conflictual evaluation phase; and generation of an execution trace allowing the subsequent reproduction of the simulation in an identical manner.

The invention relates to a reproducible parallel simulation method at electronic system level implemented by means of a multi-core discrete-event simulation computer system.

The invention relates to the field of the tools and methodologies for designing on-chip systems, and aims to increase the speed of execution of the virtual prototyping tools in order to speed up the initial on-chip system design phases.

An on-chip system can be broken down into two components: the hardware and the software. The software, which represents an increasing share of the on-chip system development efforts, must be validated as early as possible. In particular, it is not possible to wait for the first hardware prototype to be manufactured for cost and marketing lead-time reasons. To address this need, high-level modeling tools have been developed. These tools allow a high-level virtual prototype of the hardware platform to be described. The software intended for the system currently being designed can then be executed and validated on this virtual prototype.

The complexity of the modern on-chip systems also makes them complicated to optimize. The architectural choices best suited to the function of the system and to the associated software are multi-criteria choices and difficult to optimize beyond a certain point. The recourse to the virtual prototypes then makes it possible to perform rapid architectural exploration. That consists in measuring the performance levels (e.g. speed, energy consumption, temperature) of a variety of different configurations (e.g. memory size, cache configuration, number of cores) in order to choose that which offers the best trade-off. The quality of the results supplied by the initial exploration phase will greatly impact the quality and the competitiveness of the final product. The speed and the reliability of the simulation tools is therefore a crucial issue.

Most of these tools are based on the C++ hardware description library SystemC/TLM2.0 [SYSC, TLM] described in the IEEE 1666™-2011 standard.

SystemC is a hardware description language allowing the production of virtual prototypes of digital systems. These virtual prototypes can then be simulated using a discrete-event simulator. The SystemC standard indicates that this simulator must observe the co-routine semantic, i.e. the simulated concurrent processes of a model must be executed sequentially. That limits the use of the computation resources available on a machine to one single core at a time.

The invention proposes a parallel SystemC simulation kernel supporting all types of models (such as RTL, the acronym for “Register Transfer Level”, and TLM, the acronym for “Transactional Level Modeling”).

SystemC is used as explanatory support for the present description because that applies advantageously to virtual prototyping, but any discrete-event simulation system applied to electronic systems is likely to benefit from the invention described, such as Verilog or VHDL.

The parallelization of SystemC has been the subject of several approaches applicable to different families of models as follows.

A first technique aims to prevent the errors linked to the parallelization through a static code analysis as in [SCHM18]. A specialized compiler for SystemC programs makes it possible to analyze the source code of a model. It concentrates on the transitions, that is to say the code portions executed between two calls to the “wait( )” synchronization primitive. Since these portions have to be evaluated atomically, the compiler scans the possible dependencies between these transitions in order to determine whether they can be evaluated in parallel. This technique refines the analysis by distinguishing the modules and the ports in order to limit the false-positive detections. A static scheduling of the processes can then be calculated. However, in the context of a TLM model, all the processes for example accessing one and the same memory will be scheduled sequentially, rendering this approach inefficient.

Another approach encountered in [SCHU10] consists in executing in parallel all the processes of a same delta cycle. This family of techniques generally targets modeling at the RTL level. In order to remain conformal to the SystemC standard and avoid the simulation errors due to the shared resources, it is up to the developer of the model to protect the latter. Moreover, in case of multiple accesses to a shared resource on behalf of multiple processes, the order of the accesses is uncontrolled, which compromises the reproducibility of the simulation.

In order to better support the simulation of TLM models, [MELL10, WEIN16] use a temporal decoupling. That consists in dividing the model up into a set of groups of temporally independent processes. These techniques apply the principles of parallel simulation to discrete events. They consist in allowing different processes to run at different dates while guaranteeing that the latter never receive events triggered at past dates. [MELL10] turns to the sending of date-stamped messages to synchronize the processes and [WEIN16] introduces communication delays between two groups of processes, thus allowing one to take a lead at most equal to the delay of the communication channel without the risk of missing a message. However, these approaches demand the use of specific communication channels between two groups of processes and are better suited to low-level, so-called “approximately-timed” TLM models. The so-called “loosely-timed” models turn to high-level simulation techniques such as direct access to the memory (DMI, the acronym for “Direct Memory Interface”) are often incompatible with these methods.

Process zones are also used in [SCHU13]. A process zone is the term given to the set of processes and to associated resources that can be accessed by these processes. The processes of one and the same zone are executed sequentially, guaranteeing their atomicity. The processes of different zones are, for their part, executed in parallel. In order to preserve the atomicity, when a process of one zone tries to access resources belonging to another zone (variables or functions belonging to a module situated in another zone), it is interrupted, its context is migrated to the targeted zone then it is restarted sequentially with respect to the other processes of its new zone. This technique does not however guarantee the atomicity of processes in all cases. If, for example, a process Pₐ modifies a state Sₐ of the same zone before changing zone to modify a state S_{b}. During this time, a process Pb would modify S_{b} before changing zone to modify Sₐ. At this stage, each process will see the modifications made by the other process during the current evaluation phase, violating the atomicity of evaluation of the processes. Furthermore, in the presence of a shared overall memory, all the processes would be sequentialized upon access to this memory, thus exhibiting performance levels close to an entirely sequential simulation.

In [MOY13], it is possible to specify the duration of a task and execute it asynchronously in a dedicated system thread. Thus, two tasks overlapping in time can be executed simultaneously. This approach functions better for lengthy and independent processes. However, the atomicity of the processes is no longer guaranteed if they interact with one another during their execution such as, for example, by accessing a same shared memory.

In the solution proposed in [VENT16], all the processes of a same delta cycle are executed in parallel. In order to preserve the atomicity of evaluation of the processes, [VENT16] relies on the instrumentation of the memory accesses. Each memory access must then be accompanied by a call to an instrumentation function which will check whether the access relates to an address previously declared shared by the user. In this case, only the first process to access one of the shared addresses is allowed to continue in the parallel evaluation of the processes. The others must continue their execution in a sequential phase. Graphs of dependency between memory accesses are also constructed in the instrumentation of the memory accesses. At the end of each evaluation phase, these graphs are analyzed in order to check that all the processes have indeed been evaluated atomically. If they have not, the user has forgotten to declare certain addresses shared.

An approach to a similar problem is proposed in [LE14]. The objective there is to check the validity of a model by showing that, for a given input, all the possible process schedulings give the same output. In order to check that, it is formally verified that all the possible schedulings give the same output. A static C model is generated from the C++ model for that. This approach does however understand by determinism the fact that the processes are independent on scheduling. That assumption proves false for higher-level models such as the TLM models in which the interactions take place during the evaluation phase and not during the updating phase. Such a formal verification would in any case be impossible for a complex system and applies only to IPs of small dimension.

Finally, [JUNG19] proposes performing a speculative temporal decoupling using the Linux system call “fork(2)”. The fork(2) function allows the duplication of a process. The temporal decoupling here refers to a technique used in TLM modeling called “loosely-timed”, which consists in allowing a process to take the lead over all time of the simulation and to synchronize only at time intervals of so-called quantum constant duration. That greatly speeds up the simulation speed but introduces temporal errors. For example, a process can receive, at the local date t₀, an event sent by another process for which the local date was t₁ with t₁<t₀, violating the principle of causality. In order to improve the accuracy of these models using temporal decoupling, [JUNG19] implements a backtracking technique based on fork(2). In order to back up the state of the simulation, the latter is duplicated using a fork(2) call. One of the two versions of the simulation will then be executed with a delay quantum over the other. In the case of a timing error in a quantum, the delayed version will then force the synchronizations when it reaches that quantum and thus avoid the error.

[JUNG19] uses the backtracking at process level to correct simulation timing errors. However, the simulation speed is still limited by the single-core performance of the host machine. In the context of a parallel simulation, fork(2) no longer makes it possible to back up the state of the simulation because the threads are not duplicated by fork(2), rendering this approach inapplicable in the case of the invention. Furthermore, the fact that the timing errors of a model are corrected using the quantums constitutes, strictly speaking, a violation of atomicity of the processes, the latter being interrupted by the simulation kernel without a call to the wait( ) primitive. This functionality may be desired by some, but is incompatible with the will to respect the SystemC standard.

[VENT16] uses a method in which the concurrent processes of a SystemC simulation are executed in parallel execution queues each associated with a specific logic core of the host machine. A method of analyzing dependencies between the processes is put in place in order to guarantee their atomicity. [VENT16] relies on the manual declaration of shared memory zones to guarantee a valid simulation. It is however often impossible to know these zones a priori in the case of dynamic memory allocation or of virtualized memory as is often under an operating system. [VENT16] turns to a parallel phase and an optional sequential phase in the case of processes pre-empted for barred access to a shared memory in the parallel phase. Any parallelism is prevented in this sequential phase and provokes a significant slowing down.

[VENT16] proceeds to establish dependencies through multiple graphs constructed during the evaluation phase. That requires heavy synchronization mechanisms which greatly slow down the simulation to guarantee the integrity of the graphs. [VENT16] incurs the cost overhead of the overall dependency graph being completed and analyzed at the end of each parallel phase, slowing down the simulation even more. [VENT16] manipulates the execution queues monolithically, that is to say that if a process of the simulation is sequentialized, all the processes of the same execution queue will be sequentialized also.

[VENT16] proposes reproducing a simulation from a linearization of the dependency graph of each evaluation phase stored in a trace. That demands sequentially evaluating processes which may prove independent as for the graph (1→2, 1→3) which would be linearized into (1, 2, 3) whereas 2 and 3, which are not dependent on one another, can be executed in parallel.

One aim of the invention is to mitigate the abovementioned problems, and notably speed up the simulation while keeping it reproducible.

According to one aspect of the invention, a method is proposed for reproducible parallel discrete-event simulation at electronic system level implemented by means of a multi-core computer system, said simulation method comprising a succession of evaluation phases, implemented by a simulation kernel executed by said computer system, comprising the following steps:
parallel process scheduling;
dynamic detection of shared addresses of at least one shared memory of an electronic system simulated by concurrent processes, at addresses of the shared memory, using a state machine, respectively associated with each address of the shared memory;
avoidance of access conflicts at addresses of the shared memory by concurrent processes, by pre-emption of a process by the kernel when said process introduces an inter-process dependency of “read after write” or “write after read or write” type;
verification of access conflicts at shared-memory addresses by analysis of the inter-process dependencies using a trace of the accesses to the shared-memory addresses of each evaluation phase and a search for cycles in an inter-process dependency graph;
backtracking, upon a detection of at least one conflict, to restore a past state of the simulation after determination of a conflict-free order of execution of the processes of the conflictual evaluation phase during which the conflict is detected, upon a new simulation that is identical until the excluded conflictual evaluation phase; and
generation of an execution trace allowing the subsequent reproduction of the simulation in an identical manner.

Such a method allows the parallel simulation of SystemC models in observance of the standard. In particular, this method allows the identical reproduction of a simulation, facilitating debugging. It supports TLM “loosely-timed” type simulation models using temporal decoupling through the use of a simulation quantum and the direct accesses to the memory (DMI), which are very useful for achieving high simulation speeds. Finally, it makes it possible to autonomously and dynamically detect the shared addresses and therefore supports the use of virtual memories, which are essential for operating systems to run.

According to one implementation, the parallel process scheduling uses process queues, the processes of a same queue being executed sequentially by a system task associated with a logic core.

Thus, the processes placed in different queues are executed in parallel. Since the process queues can be populated manually or automatically, it is for example possible to bring together the processes that risk exhibiting dependencies or to rebalance the load of each core by migrating processes from one queue to another.

In one implementation, the backtracking uses backups of states of the simulation during the simulation made by the simulation kernel.

Thus, it is possible to restore the simulation in each of the backed-up states and to resume from that point. Made at regular intervals, these backups make it possible to moderately penalize the execution during a backtracking.

According to one implementation, the state machine of an address of the shared memory comprises the following four states:
“No_access”, when the state machine has been reset, without a process defined as owner of the address;
“Owned”, when the address has been accessed by a single process, including once in write mode, said process being then defined as owner of the address;
“Read_exclusive”, when the address has been accessed exclusively in read mode by a single process, said process being then defined as owner of the address; and
“Read_shared”, when the address has been accessed exclusively in read mode by at least two processes, without a process defined as owner of the address.

Thus, it is possible to simply classify the addresses according to the accesses which have been made to them. The state of an address will then determine the accesses which will be allowed to them, and only via a minimal memory imprint.

In one implementation, the pre-emption of a process by the kernel is determined when:
a write access is requested to an address of the shared memory by a process which is not owner in the state machine of the address, and the current state is other than “no_access”; or
a read access is requested to an address of the shared memory, the state machine of which is in the “owned” or “read_exclusive” state by a process other than the process that is the owner of the address in the state machine of the address.

Thus, no dependency between processes can be introduced during an evaluation sub-phase.

According to one implementation, the state machine of an address of the shared memory comprises the following four states:
“No_access”, when the state machine has been reset, without a process queue defined as owner of the address;
“Owned”, when the address has been accessed by a single process queue, including once in write mode, said process queue being then defined as owner of the address;
“Read_exclusive”, when the address has been accessed exclusively in read mode by a single process queue, said process queue being then defined as owner of the address; and
“Read_shared”, when the address has been accessed exclusively in read mode by at least two process queues, without a process queue defined as owner of the address.

Thus, it is possible to simply classify the addresses according to the accesses which have been made to them. The state of an address will then determine the accesses that are allowed to them, and only via a minimal memory imprint.

In one implementation, the pre-emption of a process by the kernel is determined when:
a write access is requested to an address of the shared memory by a process queue which is not owner in the state machine of the address, and the current state is other than “no_access”; or
a read access is requested to an address of the shared memory, the state machine of which is in the “owned” or “read_exclusive” state by a process queue other than the process queue that is the owner of the address in the state machine of the address.

Thus, no dependency between process queues can be introduced during an evaluation sub-phase.

According to one implementation, all the state machines of the addresses of the shared memory are reset to the “no_access” state regularly.

Thus, it is preferable to maximize the parallelism by clearing the states of the addresses observed in preceding quantums. In fact, the advantage of using quantums is not having to consider the history of access to the memory from the start of the execution of the simulation. Furthermore, between different quantums, an address may be used differently and the state which best corresponds to it may change.

In one implementation, all the state machines of the addresses of the shared memory are reset to the “no_access” state during the evaluation phase following the pre-emption of a process.

Thus, the pre-emption of a process can prove characteristic of a change of use of an address in the simulated program, and it is preferable to maximize the parallelism by clearing the states of the addresses observed in preceding quantums.

According to one implementation, the verification of access conflicts at shared-memory addresses in each evaluation phase is performed asynchronously, during the execution of the subsequent evaluation phases.

Thus, the verification of the access conflicts does not block the progress of the simulation. This method advantageously contributes to reducing the simulation time.

In one implementation, the execution trace allowing the subsequent reproduction of the simulation in an identical manner comprises a list of numbers representative of evaluation phases associated with a partial order of evaluation of the processes defined by the inter-process dependency relationships of each evaluation phase.

Thus, it is possible to re-execute the simulation in an identical manner, facilitating the debugging of the application and of the simulated platform.

According to one implementation, a backtracking, upon a detection of at least one conflict, restores a past state of the simulation, then reproduces the simulation in an identical manner until the evaluation phase that produced the conflict and then sequentially executes its processes.

Thus, it is ensured that the conflict that necessitated a backtracking will no longer be reproduced. The simulation will then be able to continue its progress.

In one implementation, a backtracking, upon a detection of at least one conflict, restores a past state of the simulation, then reproduces the simulation in an identical manner until the evaluation phase that produced the conflict and then executes its processes according to a partial order deduced from the dependency graph of the evaluation phase that produced the conflict after having eliminated therefrom one arc per cycle.

Thus, it is ensured that the conflict that necessitated a backtracking will no longer be reproduced. Furthermore, the partially parallel execution of the conflictual evaluation phase offers an acceleration compared to a sequential execution of that same phase. The simulation will then be able to continue its progress.

According to one implementation, a state of the simulation is backed up at regular intervals of evaluation phases.

Thus, it is possible to restore the simulation to a relatively close prior state in the case of conflict. This constitutes a compromise. The smaller the intervals, the more impact that will have on the overall performance levels during backups, but the cost overhead of a backtracking will be lower. On the other hand, the greater the intervals, the less impact that will have on the simulation times, but a backtracking will be more costly.

In one implementation, a state of the simulation is backed up at evaluation phase intervals that increase in the absence of detection of conflict and that decrease following conflict detection.

Thus, it is possible to limit the number of backups during phases of the simulation that do not exhibit conflicts, thereby increasing the simulation performance levels.

Also proposed, according to another aspect of the invention, is a computer program product comprising computer-executable computer code, stored on a computer-readable medium and adapted to implement a method as previously described.

The invention will be better understood on studying a few embodiments described as nonlimiting examples and illustrated by the attached drawings in which the figures are as follows:

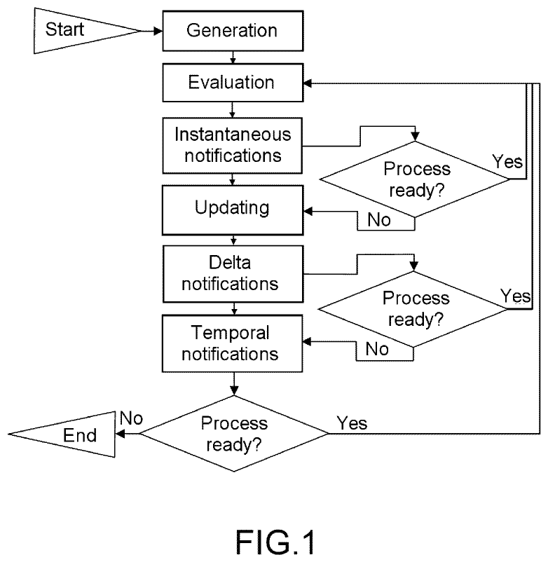

FIG. 1 schematically illustrates the phases of a SystemC simulation according to the state of the art;

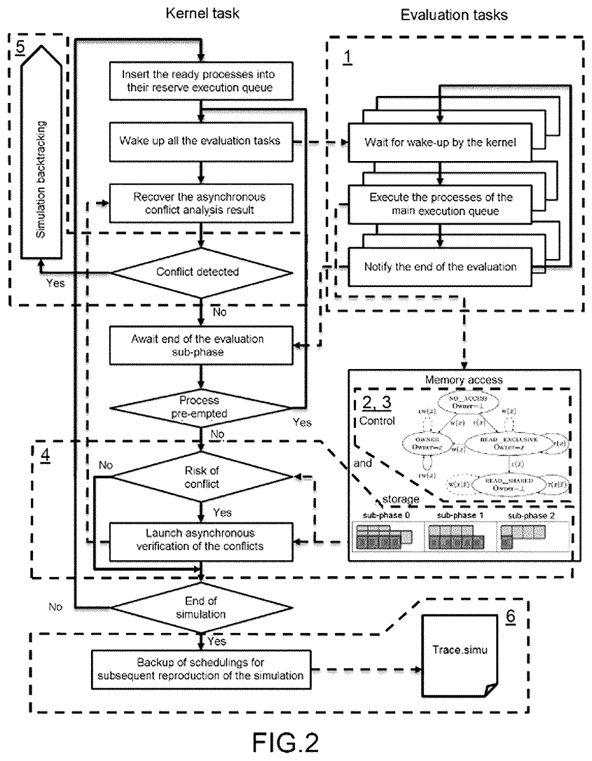

FIG. 2 schematically illustrates an implementation of the method for reproducible parallel simulation at electronic system level implemented by means of a multi-core discrete-event simulation computer system, according to an aspect of the invention;

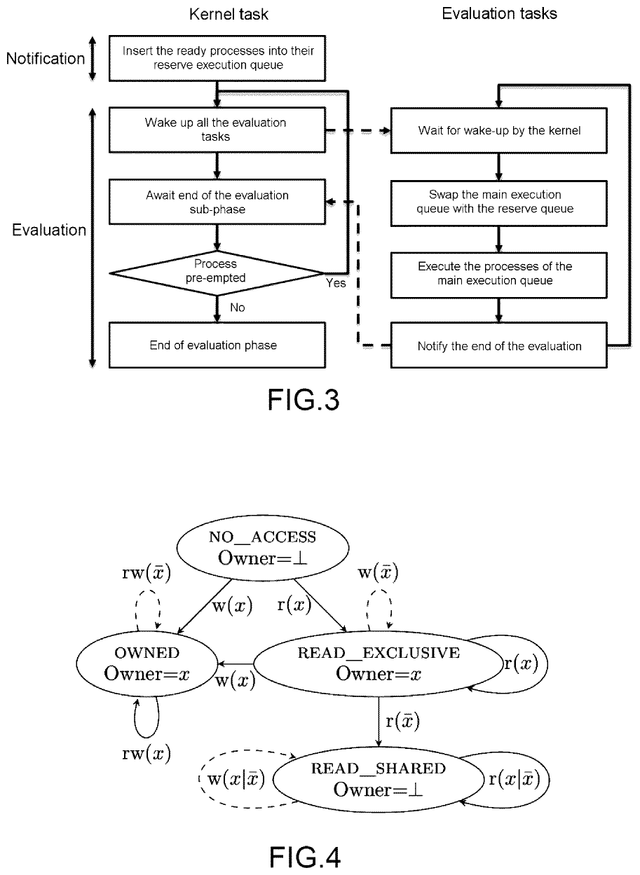

FIG. 3 schematically illustrates a parallel process scheduling, according to an aspect of the invention;

FIG. 4 schematically illustrates a state machine associated with a shared-memory address, according to an aspect of the invention;

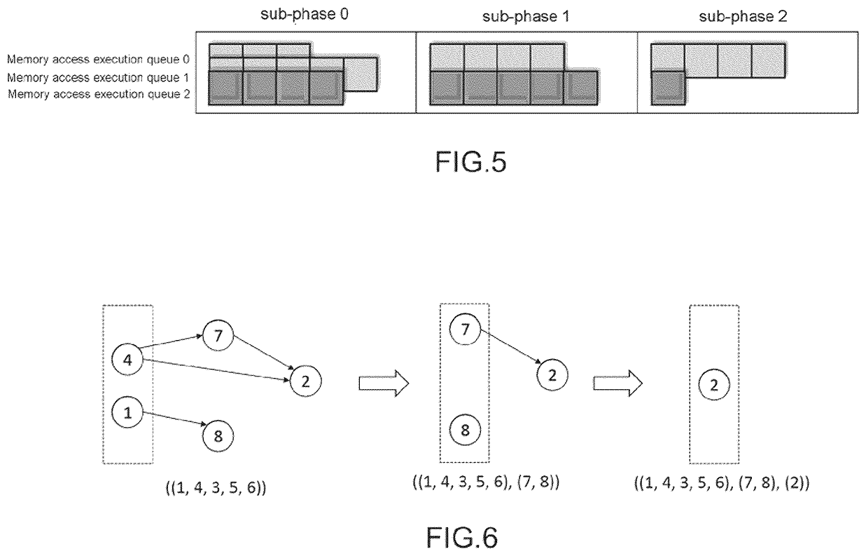

FIG. 5 schematically illustrates a data structure that allows the storage of a trace of the memory accesses performed by each of the execution queues of the simulation, according to an aspect of the invention;

FIG. 6 schematically illustrates an algorithm that makes it possible to extract a partial order of execution of processes according to an inter-process dependency graph, according to an aspect of the invention;

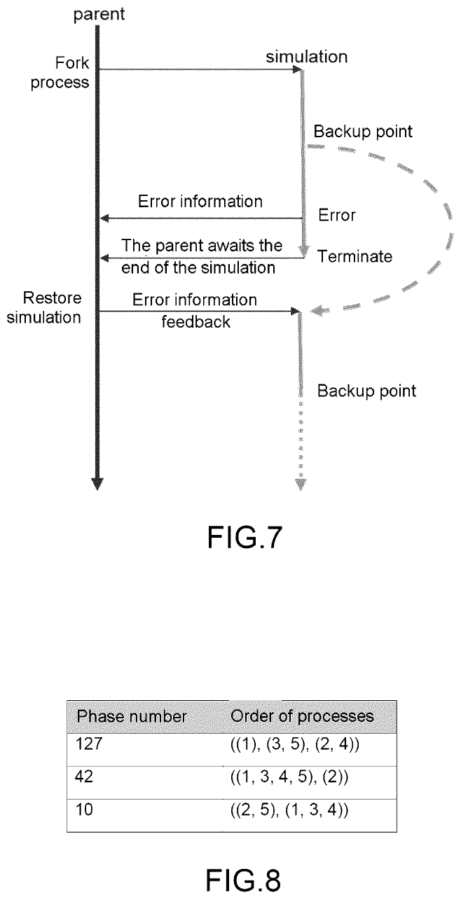

FIG. 7 schematically illustrates the backtracking procedure in case of detection of an error during the simulation, according to an aspect of the invention;

FIG. 8 schematically illustrates a trace allowing the identical reproduction of a simulation, according to an aspect of the invention;

Throughout the figures, elements that have identical references are similar.

The invention relies on monitoring memory accesses associated with a method for detecting shared addresses, and with a system that makes it possible to restore an earlier state of the simulation, and with a simulation reproduction system.

To address the need to speed up virtual prototyping tools, the modeling techniques are based on increasingly higher-level abstractions. That has made it possible to take advantage of the trade-off between speed and precision. In fact, a less detailed model requires less computation to simulate a given action, increasing the number of actions that can be simulated in a given time. It does however become increasingly difficult to raise the level of abstraction of the models without compromising the validity of the simulation results. Since simulation results that are too imprecise fatally result in costly design errors downstream, it is important to maintain an adequate precision level.

Faced with the difficulty of further increasing the level of abstraction of the virtual prototypes, the present invention proposes turning to parallelism to speed up the simulation of the on-chip systems. In particular, a technique of parallel simulation of the SystemC models is used.

A SystemC simulation breaks down into three phases, as illustrated in FIG. 1: generation during which the various modules of the model are initialized; evaluation, during which the new state of the model is calculated according to its current state via the execution of the various processes of the model; and updating, during which the results of the evaluation phase are propagated in the model with a view to the next evaluation phase.

Following the generation performed at the start of the simulation, the evaluation and updating phases alternate until the end of the simulation according to the execution diagram of FIG. 1. The evaluation phase is triggered by three types of notifications: instantaneous, delta and temporal. An instantaneous notification has the effect of programming the execution of additional processes directly during the current evaluation phase. A delta notification programs the execution of a process in a new evaluation phase running at the same date (simulation time). A temporal notification, lastly, programs the execution of a process at a subsequent date. It is this type of notification which provokes the advancing of the simulated time. The evaluation phase requires significantly more computation time than the other two. It is therefore speeding up this phase which provides the greatest gain and which forms the object of the invention.

In order to facilitate the analysis and the debugging of the simulated model and software, the SystemC standard demands a simulation to be reproducible, that is to say for it to always produce the same result from one execution to the next given the same inputs. For that, it is demanded that the different processes programmed to be executed during a given evaluation phase be executed in observance of the co-routine semantic and therefore atomically. This makes it possible to obtain an identical simulation result between two executions with the same input conditions. Atomicity is a property used in concurrent programming to denote an operation or a set of operations of a program which are executed in their entirety without being interrupted before they finish running and without an intermediate state of the atomic operation being able to be observed.

This rule demands, a priori, the use of a single core on the host machine of the simulation, which greatly limits the performance levels that can be achieved on the modern computation machines that have many cores. Now, only the observance of the co-routine semantic is actually essential: the processes must be executed in a way equivalent to a sequential execution, that is to say atomically, but not necessarily sequentially in practice. The sufficient constraint of sequentiality included in the standard can thus be degraded into a necessary constraint of atomicity: the processes must be executed as if they were alone from the start to the end of their execution. That allows opportunities to parallelize the evaluation phase of a SystemC simulation.

The main cause of non-atomicity of the processes in the case of a parallel evaluation stems from the inter-process interactions. In fact, SystemC does not constrain the processes to communicate only through the channels that language provides (routine in RTL modeling) and whose inputs are modeled only in the updating phase, providing a form of isolation during the evaluation phase. On the other hand, in TLM modeling in particular, the update phase is of lesser importance and the interactions mainly take place during the evaluation phase.

To these ends, all the functionalities offered by the C++ language can be used in a SystemC process. In particular, it is possible to access and modify shared-memory zones without particular prior protection. If a number of processes access a same memory zone simultaneously, it is possible for them to read or write values that are impossible in the case of a strict sequential execution. It is this type of interaction which constitutes the main risk of non-atomicity of the processes and that the invention specifically deals with. The violations of atomicity of the processes are called conflicts hereinafter in the present application.

The invention presents a mechanism that guarantees the atomicity of the processes which interact via shared memory only. It is moreover possible to reproduce a past simulation from a trace stored in a file.

FIG. 2 schematically represents six distinct interacting components of the invention, allowing the parallel simulation of SystemC models:
parallel process scheduling 1, for example by process queues, the processes of a same queue being assigned to a same logic core. Obviously, as a variant, the parallel scheduling can also turn to a global sharing-based allocation of the processes, that is to say that each evaluation task executes a waiting process taken from the overall queue of the processes that have to be evaluated during the present evaluation phase;
dynamic detection 2 of shared addresses of at least one shared memory of a simulated electronic system and for avoidance of access conflicts, by concurrent processes, at addresses of the shared memory, by process pre-emption by the kernel, using a state machine, respectively associated with each address of the shared memory, determining a pre-emption of a process when it introduces an inter-process dependency of “read after write” or “write after read or write” type, without requiring the prior provision of the information relating to the use made by the program of the different address ranges;
avoidance of access conflicts 3 at addresses of the shared memory by concurrent processes, by pre-emption of a process by the kernel when said process introduces an inter-process dependency of “read after write” or “write after read or write” type; verification of access conflicts 4 at shared-memory addresses by analysis of the inter-process dependencies using a trace of the accesses to the shared-memory addresses of each evaluation phase and a search for cycles in an inter-process dependency graph;
backtracking 5, upon a detection of at least one conflict, to restore a past state of the simulation after determination of an order of execution of the processes of the conflictual evaluation phase during which the conflict is detected, determined from the inter-process dependency graph, to avoid the detected conflict in a new simulation that is identical until the excluded conflictual evaluation phase; and generation of an execution trace 6 allowing the subsequent reproduction of the simulation in an identical manner.

The parallel scheduling makes it possible to execute in parallel concurrent processes of a simulation, for example by execution queues, in which case each execution queue is assigned to a logic core of the host machine. An evaluation phase is then composed of a succession of parallel sub-phases, the number of which depends on the existence of processes pre-empted during each evaluation subphase. The parallel execution of the processes necessitates precautions to preserve their atomicity. To do that, the memory accesses, which represent the most common form of interaction, are instrumented.

During the execution of the various processes of the simulation, each memory access must be instrumented by a preliminary call to a specific function. The instrumentation function will determine the possible inter-process dependencies generated by the instrumented action. If necessary, the process originating the action can be pre-empted. It then resumes its execution alongside the other pre-empted processes in a new parallel evaluation subphase. These parallel evaluation subphases are then strung together until all the processes are fully evaluated.

In order to manage the interactions by access to a shared memory, each address has associated with it a state machine indicating whether that address is accessible in read-only mode by all the processes or in read and write mode by a single process according to the previous accesses to that address. Based on the state of the address and on the access currently being instrumented, the latter is authorized or the process is pre-empted.

This mechanism aims to avoid the process evaluation atomicity violations, also called conflicts, but does not guarantee their absence. It is therefore necessary to check the absence of conflicts at the end of each evaluation phase. When no process has been pre-empted, no conflict exists, as is detailed hereinbelow in the description. If a process is pre-empted, the memory accesses likely to generate a dependency have also been stored in a dedicated structure during the evaluation of the quantum. The latter is used by an independent system thread to construct an inter-process dependency graph and check that no conflict represented by a cycle in the graph exists. This check takes place while the simulation continues. The simulation kernel recovers the results in parallel with a subsequent evaluation phase.

In case of conflict, a backtracking system makes it possible to revert to a past state of the simulation before the conflict. When an error occurs, the cause of the error is analyzed using the dependency relationships between processes and the simulation is restarted at the last backup point preceding the conflict. Scheduling to be applied to avoid a reproduction of the conflict is transmitted to the simulation before it resumes. The simulation also resumes in “simulation reproduction” mode, detailed hereinbelow in the description, which makes it possible to guarantee an identical simulation result from one simulation to the next. That avoids the point of conflict being displaced because of the non-determinism of parallel simulation and the latter occurring again.

The simulation reproduction uses a trace generated in a past simulation to reproduce the same result. This trace represents in substance a partial order in which the processes must be executed in each evaluation phase. It is stored in a file or any other storage means that persists between two simulations. A partial order is the term given to an order which is not total, i.e. an order which does not make it possible to classify all of the elements with respect to one another. In particular, the processes between which no order relationship is defined can be executed in parallel.

The invention does not require prior knowledge of the addresses shared or in read-only mode to function, which allows for greater flexibility of use. The possible conflicts are then managed by a simulation backtracking solution. It also has a level of parallelism greater than the similar solutions.

FIG. 3 schematically illustrates the parallel process scheduling, with the use of process queues. As a variant, instead of using process queues, it is possible to use an allocation of the processes by global sharing, that is to say that each evaluation task executes a waiting process taken from the global queue of the processes that have to be evaluated during the present evaluation phase.

In the rest of the description, in a nonlimiting manner, the use of process queues is more particularly described.

The parallel execution of a discrete-event simulation relies on a parallel scheduling of processes. The scheduling proposed in the present invention makes it possible to evaluate the concurrent processes of each evaluation phase in parallel. For that, the processes are assigned to different execution queues. The processes of each execution queue are then executed in turn. The execution queues are, however, executed in parallel with one another by different system tasks (or “threads”) called evaluation tasks.

An embodiment offering the best performance levels consists in allowing the user to statically associate each process of the simulation with an execution queue and to associate each execution queue with a logic core of the simulation platform. It is however possible to perform this distribution automatically at the start of simulation or even dynamically using the load balancing algorithm such as the “work stealing” algorithm.

An execution queue can be implemented using three queues, the detailed use of which will be described hereinbelow in the description: the main queue containing the processes to be evaluated during the current evaluation subphase, the reserve queue containing the processes to be evaluated in the next evaluation subphase, and the queue of the processes that have ended containing the processes for which the evaluation has ended.

The scheduling of the tasks is then performed in a distributed manner between the simulation kernel and the different execution queues, in accordance with FIG. 3, which all have a dedicated system task and, preferably, a dedicated logic core.

The evaluation phase begins at the end of one of the three possible notification phases (instantaneous, delta or temporal). At this stage, the processes ready to be executed are placed in the different reserve execution queues of each evaluation task. The kernel then wakes up all the evaluation tasks, which then begins the first evaluation subphase. Each of these tasks swaps its reserve file with its main file, and consumes the processes thereof one by one (the order is unimportant). A process can end in two ways: either it reaches a call to the “wait( )” function or clause, or it is pre-empted because of memory access introducing a dependency with a process of another evaluation queue.

In the first case, the process is removed from the main execution queue and placed in the list of processes that have ended. In the second case, it is transferred into the reserve execution queue. Once all the processes are pre-empted or ended the first parallel evaluation subphase is ended. If no process has been pre-empted, the evaluation phase is ended. If at least one process has been pre-empted, then a new parallel evaluation subphase is begun. All the tasks executing the execution queues are then once again woken up and reiterate the same procedure. The parallel evaluation subphases are thus repeated until all the processes are ended (i.e. reach a call to wait( )).

The invention relies on the checking of the interactions by access to shared memory produced by all of the processes evaluated in parallel. The objective is to guarantee that the interleaving of the memory accesses resulting from the parallel evaluation of the execution queues is equivalent to an atomic evaluation of the processes. Otherwise, there is conflict. Only the accesses to the shared memories can cause conflicts, the other accesses being independent of one another. In order to increase the flexibility of use of the parallel SystemC kernel proposed and to reduce the risk of errors relating to the declarations of shared-memory zones, the invention includes a dynamic detection of shared addresses that does not require any prior information from the user. It is thus possible to pre-empt the processes accessing shared-memory zones and therefore risking causing conflicts.

The technique presented here is based on the instrumentation of all of the memory accesses. This instrumentation is based on the identifier ID of the process performing an access and on the evaluation task executing it, on the type of access (read or write) and on the addresses accessed. This information is then processed using the state machine of FIG. 4, instantiated once for each memory address accessible on the simulated system. Each address can thus be in one of the following four states:
“No_access”, when the state machine has been reset, without a process defined as owner of the address;
“Owned”, when the address has been accessed by a single process, including once in write mode, said process being then defined as owner of the address;
“Read_exclusive”, when the address has been accessed exclusively in read mode by a single process, said process being then defined as owner of the address; and
“Read_shared”, when the address has been accessed exclusively in read mode by at least two processes, without a process defined as owner of the address.

In this case, the pre-emption of a process by the kernel is determined when:
a write access is requested to an address of the shared memory by a process which is not owner in the state machine of the address, and the current state is other than “no_access”; or
a read access is requested to an address of the shared memory, the state machine of which is in the “owned” or “read_exclusive” state by a process different from the process that is the owner of the address in the state machine of the address.

As a variant, each address can be in one of the four following states:
“No_access”, when the state machine has been reset, without a process queue defined as owner of the address;
“Owned”, when the address has been accessed by a single process queue, including once in write mode, said process queue being then defined as owner of the address;
“Read_exclusive”, when the address has been accessed exclusively in read mode by a single process queue, said process queue being then defined as owner of the address; and
“Read_shared”, when the address has been accessed exclusively in read mode by at least two process queues, without a process queue defined as owner of the address.

In this case, the pre-emption of a process by the kernel is determined when:
a write access is requested to an address of the shared memory by a process queue which is not owner in the state machine of the address, and the current state is different from “no_access”; or
a read access is requested to an address of the shared memory, the state machine of which is in the “owned” or “read_exclusive” state by a process queue different from the process queue that is the owner of the address in the state machine of the address.

In this state machine, the owners are evaluation tasks (and not individual SystemC processes), that is to say the system task in charge of evaluating the processes listed in its evaluation queue. That makes it possible to avoid processes of a same evaluation queue being mutually blocked while it is guaranteed that they cannot be executed simultaneously.

The transitions represented by solid lines between the states define the accesses authorized during the parallel evaluation phase and those in broken lines define the accesses causing the pre-emption of the process; r and w correspond respectively to read and write; x is the first evaluation task to access the address since the last reset, and x̅ is any evaluation task other than x.

The “owned” state indicates that only the owner of the address can access it and the “read_shared” state indicates that only reads are authorized for all the evaluation tasks. The “read_exclusive” state is important when the first access to an address after a reset of the state machine is a read by a task T. If the “read_exclusive” state were not present and a read by a task T led immediately to a transition to a “read_shared” state, T could no longer write to that address without being pre-empted, even if no other process has accessed that address in the meantime. That would typically affect all the addresses of the memory stack of the processes executed by T and would therefore lead to a quasi-systematic pre-emption of all the processes of T and of all the processes of the other tasks in an identical manner. With the “read_exclusive” state, it is possible to wait for a read of another thread x̅ or else a write of x to decide with greater reliability on the nature of the address considered.

A process is pre-empted as soon as it tries to perform an access which would render the shared address other than “read-only” since the last reset of the state machine. That corresponds to a write to an address by a process, the evaluation task of which is not the owner (unless in the “no_access” state), or to a read access to an address in the “owned” state and the owner of which is another evaluation task. These pre-emption rules guarantee that, between two resets, it is impossible for an evaluation task to read (respectively write) an address previously written (respectively written or read) by another evaluation task. That therefore guarantees the absence of dependencies linked to the memory accesses between the processes of two distinct evaluation queues between two resets.

In order to implement this technique, a memory access storage function RegisterMemoryAccess( ) that takes as argument the address of an access, its size and its type (read or write) is made available to the user. The latter must call this function before each memory access. This function recovers the identifier of the calling process and of its evaluation task, and the instance of the state machine associated with the accessed address is updated. Depending on the transition performed, the process can either continue and perform the instrumented memory access or be pre-empted to continue in the next parallel subphase.

The state machines are stored in an associative container, the keys of which are addresses and the values of the instances of the state machine represented in FIG. 3. This container must support concurrent access and modification. That has been achieved in two different ways, notably according to the size of the memory space simulated. When it is possible to have all of the state machines pre-allocated contiguously (i.e. in an std:vector in C++), this solution is prioritized because it offers the state machines minimum access times. This technique is to be prioritized for example on systems using a physical memory space of 32 bits or less. For memory spaces of greater size, a table-type structure of the multilevel pages can be used (a page denotes a contiguous and aligned set of given size, such as a few MB, of addresses). This structure requires a greater number of indirections (typically three) to access the desired state machine but can support any memory space size with a memory cost proportional to the number of pages accessed during the simulation and an access time proportional to the size of the memory space in bits.

Once the state machine of the accessed address is recovered, the transition to be performed is determined from the current state and the characteristics of the access currently being instrumented. The transition must be calculated and applied atomically using, for example, an atomic instruction of compare and swap type. For that to be effective and not require additional memory space, the set of fields that make up the state of an address must be able to be represented on the greatest number of bits that can be manipulated atomically (128 bits on AMD64), the lowest being the best. These fields are, in this case, one byte for the state of the address, one byte for the identifier ID of the evaluation task that is the owner of the address and two bytes for the reset counter, detailed hereinbelow in the description, for a total of 32 bits. If the atomic update of the state fails, that means that another process has updated the same state machine simultaneously. The state machine update function is then recalled to attempt the update once again. That is repeated until the update of the state machine succeeds. A performance optimization consists in not performing the atomic “compare and swap” if the transition taken loops to the same state. That is possible because the accesses causing a transition which loops to a same state are commutative with all the other accesses of a same evaluation subphase. That is to say that the order in which these accesses looping to a same state are recorded with respect to the accesses immediately adjacent in time has no influence on the final state of the state machine and does not change the processes that are possibly pre-empted.

The update function of the state machine of the address accessed indicates finally if the calling process must be pre-empted or not by returning for example a Boolean.

In order to resume the execution of a process only once the processes on which it depends are ended, it is sufficient, in the next evaluation subphase, to check whether the expected processes are ended. If such is not the case, the process is pre-empted again, otherwise is resumes its course. The list of the processes that are ended is constructed by the kernel at the end of each evaluation subphase in which at least one process has been pre-empted. To that end, the kernel aggregates for that the lists of ended processes of each evaluation task.

The state machines are used to determine the nature of the different addresses and to authorize or not certain accesses as a function of the state of these addresses. However, in an application, some addresses can change use. For example, a buffer memory can be used to store in it an image which is then processed by several threads subsequently. When the buffer memory is initialized, it is commonplace for only a single task to access that memory. The SystemC process simulating this task is then owner of the addresses contained in the buffer memory. However, during the image processing phase, multiple processes access this image in parallel. If the result of the image processing is not placed directly in the buffer memory, the latter would then necessarily be entirely in the “read_shared” state. Now, it is impossible to go from the “owned” state to the “read_shared” state without first proceeding with a reset of the state machine, that is to say a forced return to the “no_access” state.

The performance levels are then widely impacted by the reset policy adopted (when and what state machines to reset), and by the implementation of this reset mechanism. One embodiment of the reset policy is as follows, but others can be implemented: when a process accesses a shared address and it is pre-empted, all of the state machines are reset in the next parallel evaluation subphase. That is justified by the following observation: often, an access to a shared address is symptomatic of the situation described above, that is to say that a set of addresses first accessed by a given process are then only read by a set of processes or accessed by another process exclusively (it can be said that the data migrate from one task to another). The state machines of these addresses must then be reset to go back to a new, more suitable state. It is however difficult to anticipate which exactly are the addresses which must change state. The option retained is therefore to reset all of the address space based on the fact that the addresses which did not need to be reset will rapidly revert to their preceding state.

The implementation of this reset involves a counter C stored with the state machine of each address. Upon each update of the state machine, the value of a global counter C_{g} external to the state machine is given as additional argument. If the value of C_{g} differs from that of C, the state machine must be reset before performing the transition and C is updated to the value C_{g}. Thus, to trigger the reset of all of the state machines, it is sufficient to increment C_{g}. The counter C must be updated with the state of the state machine and the possible owner of the address atomically.

In the case described previously, C uses two bytes. That means that if C_{g} is incremented exactly 65,536 times between two accesses to a given address, C and C_{g} remain equal and the reset does not take place, which potentially and very rarely leads to pointless pre-emptions but does not compromise the validity of the technique.

This reset technique makes it possible to not have to perform a reset of all the state machines accessed between two evaluation phases for example. That would result in a very significant slowing down. In the solution proposed, it is the evaluation tasks which perform the reset as required when they access an address.

Regarding the a posteriori checking of the conflicts, as explained previously, no dependency between processes belonging to distinct execution queues can be introduced between two resets of the state machines, because any process attempting a memory access which would introduce such a dependency is pre-empted before being able to perform its access. If no process has been pre-empted at the end of the first parallel evaluation subphase, that means that no dependency exists between the execution queues. Now, the processes of a same execution queue are evaluated successively, warning of the occurrence of a circular dependency between them within a given evaluation subphase. Consequently, no circular dependency exists between the set of processes and therefore no conflict. No additional check is then required if an evaluation phase is composed only of a single evaluation subphase. In practice, most of the evaluation phases require only a single subphase and are therefore immediately guaranteed conflict-free. This specific feature of the invention is one of its greatest acceleration factors.

However, if processes have been pre-empted during the first parallel evaluation subphase, several parallel evaluation subphases take place and dependencies can appear with the risk of a conflict. It is consequently necessary to check the absence of conflicts at the end of the complete evaluation phase in these cases. This check is done a posteriori, that is to say that the dependencies between the processes are not established during the evaluation phase but once the latter is ended and, for example, asynchronously. To do this, an access recording structure “AccessRecord”, containing all of the memory accesses performed during an evaluation phase is used. This structure allows the concurrent storage of the accesses performed during each parallel evaluation subphase.

Because of the guaranteed absence of dependency in each parallel evaluation subphase, the order between the execution queues of the accesses recorded during each subphase is unimportant. These accesses can therefore be recorded in parallel in a number of independent structures. The record structure “AccessRecord” is therefore composed, for each subphase, of a vector for each execution queue as represented in FIG. 5. Any ordered data structure can be used in place of the vector. At the end of the call to the access function to a memory register “RegisterMemoryAccess( )”, if the calling process is not pre-empted, it inserts into the vector of its execution queue the characteristics of the instrumented memory access: address, number of bytes accessed, type of access and ID of the process.

At the end of each evaluation phase, if a number of subphases have taken place, the simulation kernel entrusts the check for the absence of conflict to a dedicated system task. In order not to have to systematically create a new task without waiting for checking of a prior evaluation phase to end, a pool of tasks is used. If no task is available, a new task is added to it. The checking of the evaluation phase is then performed asynchronously during the continuous simulation. Another access recording structure “AccessRecord”, itself derived from a pool, is used for the next evaluation phase.

The checking task then enumerates the accesses contained in the access recording structure “AccessRecord” from the first to the last evaluation subphase. The vectors of each subphase of the access recording structure “AccessRecord” must be processed one after the other in any order. A read at a given address introduces a dependency with the last writer of that address and a write introduces a dependency with the preceding writer and all the readers since the latter. This rule does not apply when a dependency relates to a process with itself. An inter-process dependency graph is then constructed. Once the graph is completed, the latter has for vertices all of the processes involved in a dependency which are themselves represented by oriented arcs. A search for cycles is then done in the graph in order to detect any circular dependency between processes symptomatic of a conflict. If no cycle, and therefore no conflict, is present, then a list of sets of processes is produced according to their level in the dependency graph: the nodes that have no predecessor are grouped together with the processes not included in the graph; the other nodes are grouped together in such a way that no dependency exists in each group and that the groups are of maximum size. An algorithm is illustrated in FIG. 6 with eight processes comprising the following steps:
step 1: group together the processes without predecessor and those not included in the graph;
step 2: remove from the graph the processes already grouped together;
step 3: if processes remain, group together the processes without predecessor, otherwise end.
step 4: resume at step 2.
   It is this list of groups of processes which is used in the simulation reproduction described hereinafter in the description.

The recovery of the result of a verification of the conflicts is performed by the simulation kernel in parallel with a subsequent evaluation phase. Once the latter has woken up the evaluation tasks, it tests whether verification results are ready before waiting for the end of the current evaluation subphase. If at least one verification result is ready, the kernel recovers a structure indicating the verified phase, whether there has been a conflict and, in the absence of conflict, the list of groups of processes described above. This list will then be able to be used to reproduce the current simulation subsequently in an identical manner. A performance optimization consists in reusing the access record structure “AccessRecord”, which has just been verified, in a subsequent evaluation phase. That makes it possible to conserve the buffer memories of the underlying vectors. If the latter had to be reallocated in each evaluation phase, the performance levels would be reduced.

The instrumentation of the memory accesses using the memory access recording function “RegisterMemoryAccess( )” aims, on the one hand, to avoid the occurrence of conflicts and, on the other hand, to check a posteriori that the accesses performed in a given evaluation phase correspond in fact to a conflict-free execution. In order for this verification to be reliable, it is necessary that the order in which the accesses are recorded in an access record structure “AccessRecord” does actually correspond to the order of the accesses actually performed. Consider now the example of two processes P0 and P1 both performing an access to an address A. These writes must be preceded by a call to the memory access record function “RegisterMemoryAccess( )” before being applied in memory. Since P0 and P1 are being executed in parallel, the observed order of the calls to the memory access record function “RegisterMemoryAccess( )” can differ from the observed order of the writes which ensue therefrom. This reversal of order could totally invalidate the validity of the method set forth: if the recorded order of two writes is reversed with respect to the real order of the writes, then the recorded dependency is reversed with respect to the real dependency and conflicts could happen unperceived.

A simple method that makes it possible to safeguard from this problem consists in grouping each memory access and the call to the memory access record function “registerMemoryAccess( )” which precedes it in a section protected by a mutual exclusion, or “mutex” for short. This solution is functionally correct but drastically slows down the simulation. On the other hand, a crucial property of the invention totally dispenses with synchronization. In fact, as explained above, any memory access generating a dependency gives rise to the pre-emption of the responsible process before it can perform this access. Consequently, no dependency can occur between two processes belonging to distinct execution queues. In particular, it is impossible for two accesses generating a dependency to take place in the same evaluation subphase and therefore for a dependency relationship to be reversed.

Regarding the recovery of the conflicts, when the verification of the conflicts indicates that a conflict has occurred, the simulation no longer observes the SystemC standard starting from the evaluation phase having a conflict. The invention relies on a backtracking system to restore the simulation to an earlier valid state.

Any backtracking method could be employed. The embodiment presented here relies on a backtracking technique at the system process level. The CRIU (acronym for “Checkpoint/Restore In Userspace”) tool available in Linux can be employed. It allows the state of a complete process at a given instant to be written in files. That includes in particular an image of the memory space of the process and the state of the processor registers useful at the time of the backup. It is then possible, from these files, to relaunch the backed-up process from the backup point. CRIU also makes it possible to perform incremental process backups. That consists in writing to the disk only the memory pages which have changed since the last backup and consequently exhibit a gain in speed. CRIU can be controlled via an RPC interface based on the Protobuf library.

The general principle of the backtracking system is represented schematically in FIG. 7. When the simulation is launched, the process of the simulation is immediately duplicated using the system call fork(2). It is imperative for this duplication to occur before the creation of additional tasks because the latter are not duplicated by the call to fork(2). The child process obtained will be called the simulation and it is that which performs the actual simulation. During the simulation, backup points follow one another until any error which corresponds to a conflict is encountered. In this case, the simulation process transmits to the parent process the information relating to this conflict, notably the number of the evaluation phase in which the conflict occurred and the information useful to the reproduction of the simulation up to the point of conflict, as described hereinbelow in the description. The order of execution to be applied in order to avoid the conflict can then be transmitted. That is obtained by eliminating an arc for each loop in the dependency graph of the phase having caused the conflict and by applying the algorithm for generating the list of groups of processes. The parent process then waits for the simulation process to end before relaunching it using CRIU. Once the simulation process is restored to a state prior to the error, the parent process returns to the simulation process the information relating to the conflict which caused the backtracking. The simulation can then resume and the conflict can be avoided. Once the conflictual evaluation phase is passed, a new backup is performed.

The effectiveness of the invention relies on a suitable backup policy. The spacing of the backups must in fact be chosen so as to minimize the number thereof while avoiding having any backtracking return to a backup that is too old. The first backup policy consists in backing up only at the very start of the simulation and then waiting for the first conflict, if one occurs. That is very well suited to the simulations that do not cause, or cause very few, conflicts. Another policy consists in backing up the simulation at regular intervals, for example every 1000 evaluation phases. It is also possible to vary this backup interval by increasing it in the absence of conflict and reducing it following a conflict for example. When a backup point is reached, the simulation kernel begins by waiting for all the verifications of conflicts of the preceding evaluation phases to be ended. If no conflict has occurred, a new backup is performed.

Regarding the reproduction of a simulation, the SystemC simulation kernel proposed can operate in simulation reproduction mode. This mode of operation uses a trace generated by the simulation to be reproduced. This trace then makes it possible to check the execution of the processes in order to guarantee a simulation result identical to the simulation having produced the trace, thus observing the demands of the SystemC standard. The trace used by the invention is composed of the list of the numbers of the evaluation phases during which inter-process dependencies have occurred, with which are associated the orders in which these processes must be executed in each of these evaluation phases to reproduce the simulation. An example is given in the table of FIG. 8, in which, for each phase listed, each group of processes (inner parentheses) can be executed in parallel but the groups must be executed in distinct sequential subphases. This trace is stored in a file (for example by serialization) between two simulations or any other storage means that persists following the end of the simulation process.

The simulation reproduction uses two containers: one, named Tw (“Trace write”), used to store the trace of the current simulation, the other, named Tr (“Trace read”), containing the trace of a preceding simulation entered as parameter of the simulation if the simulation reproduction is activated. A new element is inserted into Tw after each end of checking of the conflicts. Tw is serialized in a file at the end of each simulation.

If the simulation reproduction is activated, Tr is initialized at the start of simulation using the trace of a past simulation as argument for the program. At the start of each evaluation phase, a check is then carried out to see if its number is included in the elements of Tr. If such is the case, the list associated with this phase number in Tr is used to schedule the evaluation phase. For that, the list of the processes to be executed in the next parallel evaluation subphase is passed to the evaluation threads. When woken up, the latter check, before beginning the evaluation of each process, that the latter is included in the list. If not, the process is immediately placed in the reserve execution queue to be evaluated subsequently.

Tr can be implemented using an associative container with the evaluation phase numbers as key, but it is more effective to use a sequential container of vector type in which pairs or couples (phase number; order of the processes) are stored in descending order of the evaluation phase numbers (each line of the table of FIG. 8 is a pair of the vector). In order to check whether the current evaluation phase is present in Tr, it is then sufficient to compare its number to the last element of Tr and, if they are equal, to eliminate the latter from Tr at the end of the evaluation phase.

If the simulation reproduction is not activated, conflicts can occur followed by a backtracking of the simulation. The simulation reproduction mode between the return point and the point where the conflict has occurred is then activated. That avoids having a different conflict occur following the backtracking because of the non-determinism of the simulation. Tw is then transmitted via the backtracking system in order to initialize Tr. In addition to being sorted, the elements corresponding to evaluation phases earlier than the return point must be deleted from Tr. The simulation reproduction can be deactivated once the point of conflict is passed.

A performance optimization consists in deactivating the systems for detecting shared addresses and for checking conflicts when the simulation reproduction is activated. Indeed, the latter guarantees that the new instance of the simulation supplies a result identical to the simulation reproduced. Now, the trace obtained at the end of the latter makes it possible to avoid all the conflicts which could occur. In the case of a backtracking, it is however important to deactivate the simulation reproduction mode after the point of conflict if this optimization is used.

### BIBLIOGRAPHY

SCHM18 T. Schmidt, Z. Cheng, and R. Dömer, “Port call path sensitive conflict analysis for instance-aware parallel SystemC simulation,” in DATE 2018
SCHU10 C. Schumacher, R. Leupers, D. Petras, and A. Hoffmann, “parSC: Synchronous parallel SystemC simulation on multi-core host architectures,” in CODES+ISSS 2010
MELL10 A. Mello, I. Maia, A. Greiner, F. Pecheux, I. M. and A. Greiner, and F. Pecheux, “Parallel Simulation of SystemC TLM 2.0 Compliant MPSoC on SMP Workstations,” in DATE 2010
WEIN16 J. H. Weinstock, R. Leupers, G. Ascheid, D. Petras, and A. Hoffmann, “SystemC-Link: Parallel SystemC Simulation using Time-Decoupled Segments,” in DATE 2016
SCHU13 C. Schumacher et al., “legaSCi: Legacy SystemC Model Integration into Parallel Systemc Simulators,” in IPDPSW 2013.
MOY13 M. Moy, “Parallel programming with SystemC for loosely timed models: A non-intrusive approach,” in DATE 2013
VENT16 N. Ventroux and T. Sassolas, “A new parallel SystemC kernel leveraging manycore architectures,” in DATE 2016
LE14 H. M. Le and R. Drechsler, “Towards verifying determinism of SystemC designs,” in DATE 2014
JUNG19 M. Jung, F. Schnicke, M. Damm, T. Kuhn, and N. Wehn, “Speculative Temporal Decoupling Using fork( )” in DATE 2019

1. A method for reproducible parallel discrete-event simulation at electronic system level implemented by means of a multi-core computer system, said simulation method comprising a succession of evaluation phases, implemented by a simulation kernel executed by said computer system, comprising the following steps:
parallel process scheduling;
dynamic detection of shared addresses of at least one shared memory of an electronic system simulated by concurrent processes, at addresses of the shared memory, using a state machine, respectively associated with each address of the shared memory;
avoidance of access conflicts at addresses of the shared memory by concurrent processes, by pre-emption of a process by the kernel when said process introduces an inter-process dependency of “read after write” or “write after read or write” type;
verification of access conflicts at shared-memory addresses by analysis of the inter-process dependencies using a trace of the accesses to the shared-memory addresses of each evaluation phase and a search for cycles in an inter-process dependency graph;
backtracking, upon detection of at least one conflict, to restore a past state of the simulation after determination of a conflict-free order of execution of the processes of the conflictual evaluation phase during which the conflict is detected, upon a new simulation that is identical until the excluded conflictual evaluation phase; and
generation of an execution trace allowing the subsequent reproduction of the simulation in an identical manner.

2. The method as claimed in claim 1, wherein the parallel process scheduling uses process queues, the processes of a same queue being executed sequentially by a system task associated with a logic core.

3. The method as claimed in claim 1, wherein the backtracking uses backups of states of the simulation during the simulation made by the simulation kernel.

4. The method as claimed in claim 1, wherein the state machine of an address of the shared memory comprises the following four states:
“No_access” when the state machine has been reset, without a process defined as owner of the address;
“Owned”, when the address has been accessed by a single process, including once in write mode, said process being then defined as owner of the address;
“Read_exclusive” when the address has been accessed exclusively in read mode by a single process, said process being then defined as owner of the address; and
“Read_shared”, when the address has been accessed exclusively in read mode by at least two processes, without a process defined as owner of the address.

5. The method as claimed in claim 4, wherein the pre-emption of a process by the kernel is determined when:
a write access is requested to an address of the shared memory by a process which is not owner in the state machine of the address, and the current state is other than “no_access”; or
a read access is requested to an address of the shared memory, the state machine of which is in the “owned” or “read_exclusive” state by a process other than the process that is the owner of the address in the state machine of the address.

6. The method as claimed in claim 1, wherein the state machine of an address of the shared memory comprises the following four states:
“No_access”, when the state machine has been reset, without a process queue defined as owner of the address;
“Owned” when the address has been accessed by a single process queue, including once in write mode, said process queue being then defined as owner of the address;
“Read_exclusive”, when the address has been accessed exclusively in read mode by a single process queue, said process queue being then defined as owner of the address; and
“Read_shared”, when the address has been accessed exclusively in read mode by at least two process queues, without a process queue defined as owner of the address.

7. The method as claimed in claim 6, wherein the pre-emption of a process by the kernel is determined when:
a write access is requested to an address of the shared memory by a process queue which is not owner in the state machine of the address, and the current state is other than “no_access”; or
a read access is requested to an address of the shared memory, the state machine of which is in the “owned” or “read_exclusive” state by a process queue other than the process queue that is the owner of the address in the state machine of the address.

8. The method as claimed in claim 4, wherein all the state machines of the addresses of the shared memory are reset to the “no_access” state regularly.

9. The method as claimed in claim 4, wherein all the state machines of the addresses of the shared memory are reset to the “no_access” state during the evaluation phase following the pre-emption of a process.

10. The method as claimed in claim 1, wherein the verification of access conflicts at shared-memory addresses in each evaluation phase is performed asynchronously, during the execution of the subsequent evaluation phases.

11. The method as claimed in claim 1, wherein the execution trace allowing the subsequent reproduction of the simulation in an identical manner comprises a list of numbers representative of evaluation phases associated with a partial order of evaluation of the processes defined by the inter-process dependency relationships of each evaluation phase.

12. The method as claimed in claim 1, wherein a backtracking, upon a detection of at least one conflict, restores a past state of the simulation, then reproduces the simulation in an identical manner until the evaluation phase that produced the conflict and then sequentially executes its processes.

13. The method as claimed in claim 1, wherein a backtracking, upon a detection of at least one conflict, restores a past state of the simulation, then reproduces the simulation in an identical manner until the evaluation phase that produced the conflict and then executes its processes according to a partial order deduced from the dependency graph of the evaluation phase that produced the conflict after having eliminated therefrom one arc per cycle.

14. The method as claimed in claim 1, wherein a state of the simulation is backed up at regular intervals of evaluation phases.

15. The method as claimed in claim 1, wherein a state of the simulation is backed up at evaluation phase intervals that increase in the absence of detection of conflict and that decrease following conflict detection.

16. A computer program product comprising program code instructions stored on a computer-readable medium, for implementing steps of the method as claimed in claim 1 when said program is run on a computer.
